(19) United States
(12) Patent Application Publication
(10) Pub. No.: US 2025/0081993 A1
(43) Pub. Date: Mar. 13, 2025

(54) DRY PET FOOD

(71) Applicant: Unicharm Corporation, Ehime (JP)

(72) Inventors: Junpei Yamaguchi, Itami-shi (JP); Masaki Shiota, Itami-shi (JP)

(73) Assignee: Unicharm Corporation, Ehime (JP)

(21) Appl. No.: 18/960,607

(22) Filed: Nov. 26, 2024

Related U.S. Application Data
(63) Continuation of application No. PCT/JP2023/019896, filed on May 29, 2023.

(30) Foreign Application Priority Data
May 31, 2022 (JP) 2022-089220

(51) Int. Cl. A23K 50/42; A23K 10/22; A23K 10/30

(52) U.S. Cl. CPC A23K 50/42; A23K 10/22; A23K 10/30

(57) ABSTRACT

A dry pet food includes granules of an ingredient mixture that includes a powder ingredient including soybean protein, a raw meat ingredient consisting of one or both of animal meat and fish meat, and an oil and fat ingredient. A content of the raw meat ingredient is more than 36% with respect to a total amount of the ingredient mixture.

### CROSS-REFERENCE TO RELATED APPLICATIONS

The present application is a continuation application of International Application No. PCT/JP2023/019896, filed May 29, 2023, which claims priority to Japanese Patent Application No. 2022-089220, filed May 31, 2022. The contents of these applications are incorporated herein by reference in their entirety.

### BACKGROUND

### Technical Field

The present invention relates to a dry pet food.

### Discussion of the Background

A demand for dry pet foods as pet foods to be fed daily has been increasing from the viewpoints of ease of handling, good storage properties, and the like. However, in many cases, dry pet foods contain powder ingredients at a high ratio compared to pet foods with a high moisture content, such as soft dry foods, semi-moist foods, and wet foods, which may result in degraded palatability.

In recent years, there has been an increasing demand for healthy and highly palatable dry pet foods using good quality ingredients. Raw meat ingredients such as animal meat and fish meat are attracting attention as raw materials of such dry pet foods.

For example, Patent Literature 1 discloses a dry food obtained by uniformly pulverizing a mixture containing 30 to 65 weight % of corn, 5 to 20 weight % of rice, 15 to 35 weight % of meat, 10 to 30 weight % of dietary fibers, 0.15 to 2.0 weight % of inorganic salts, 0.01 to 0.2 weight % of vitamins, and 0.01 to 5.2 weight % of minerals, subjecting the pulverized product to a heat treatment, and forming the heat-treated product.

In addition, Patent Literature 2 discloses a pet food composition including at least about 40 weight % of meat, and a cellulosic material in an amount effective to allow extrusion and cutting of the composition after passing through an extruder.

### Patent Literature

Patent Literature 1: Japanese Patent Publication No. 2003-274868

Patent Literature 2: Japanese Patent Application Laid-Open No. 2003-518373

In recent years, in the human food industry, there has been an increase in products that focus on the ingredients and quality of raw materials. Along with this, there is also an increasing demand for pet owners to give pet foods made with good quality ingredients to beloved pets, and pet foods that contain a larger amount of raw materials themselves as ingredients are desired.

### SUMMARY

As a result of investigations conducted by the inventors of the present invention, when the blending amount of a raw meat ingredient is increased in the production of dry food, granulation of food granules themselves cannot be performed, or even when granulation can be performed, the yield rate is significantly lowered. In addition, there are cases where the produced food granules are unstable and the mouthfeel is inferior, or there are cases where the shape of the food granules themselves cannot be maintained.

On the other hand, even in a case where 40% or more of the raw meat ingredient is contained as in Patent Literature 2, in view of the above, when blending dietary fibers such as a cellulosic material, palatability is lowered.

One or more embodiments provide a dry pet food which contains a large amount of raw meat ingredient and has good palatability.

(1) A dry pet food according to one or more embodiments includes: granules of an ingredient mixture containing a powder ingredient, at least one raw meat ingredient selected from the group consisting of animal meat and fish meat, and an oil and fat ingredient, wherein a content of the raw meat ingredient is more than 36% with respect to a total amount of the ingredient mixture, and the powder ingredient includes soybean protein.

(2) The dry pet food according to (1), wherein the raw meat ingredient is a main ingredient of the ingredient mixture.

(3) The dry pet food according to (1) or (2), wherein a content of the soybean protein is 5% to 30% with respect to the total amount of the ingredient mixture.

(4) The dry pet food according to any one of (1) to (3), wherein a content of dietary fibers in the ingredient mixture is 10% or less with respect to the total amount of the ingredient mixture.

(5) The dry pet food according to any one of (1) to (4), wherein the powder ingredient includes corn as a cereal ingredient.

(6) The dry pet food according to any one of (1) to (5), wherein a content of the oil and fat ingredient is 3.5% or more with respect to the total amount of the ingredient mixture. (7) A dry pet food comprising: a first granule of a first ingredient mixture containing a powder ingredient, at least one raw meat ingredient selected from the group consisting of animal meat and fish meat, and an oil and fat ingredient; and a second granule of a second ingredient mixture in which a content of the raw meat ingredient is lower than a content of the raw meat ingredient of the first ingredient mixture or no raw meat ingredient is contained, wherein the content of the raw meat ingredient of the first ingredient mixture is more than 36% with respect to a total amount of the first ingredient mixture.

(8) The dry pet food according to (7), wherein a content ratio of the first granule is less than 25% with respect to a total amount of the first granule and the second granule.

(9) The dry pet food according to (7) or (8), wherein the first granule has an arc-shaped corner part, and the second granule has a modified cross section.

(10) The dry pet food according to any one of (7) to (9), wherein the first ingredient mixture contains fish meat as the raw meat ingredient, and the second ingredient mixture contains fish meat excluding the fish meat contained in the first ingredient mixture.

(11) The dry pet food according to any one of (7) to (10), wherein the first granule has a darker color than the second granule.

According to one or more embodiments, a dry pet food which contains a large amount of raw meat ingredient and has good palatability can be obtained.

### DESCRIPTION OF THE EMBODIMENTS

In the present description, the term “pet” refers to an animal raised by a human. In a narrower sense, a pet is an animal that is cherished by its owner. Furthermore, the “pet food” means feed for pets. The pet food according to one or more embodiments can be sold as “animal fodder” or “animal feed”.

The term “palatability” in the present description is an index indicating whether a pet likes to eat, and palatability arises from mouthfeel, taste, odor, and the like.

In the present description, the moisture content percentage (weight %) of a pet food is determined by an atmospheric heating and drying method. The moisture content percentage determined by this method also includes the moisture in the ingredients.

### Atmospheric Pressure Heating and Drying Method

The weight of an aluminum weighing can (W1 grams) is measured in advance as a constant weight value. A sample is introduced into this aluminum weighing can, and the weight (W2 grams) is weighed. Next, the sample is dried under the conditions of 135° C. for 2 hours by using a forced circulation type warm air dryer. After the sample is left to cool in a dry atmosphere (in a silica gel desiccator), the weight (W3 grams) is weighed. From each of the weights obtained, the moisture content percentage is determined by using the following formula.

Moisture content percentage (unit: weight %)=(W2−W3)÷(W2−W1)×100

### Method of Measuring Hardness

In the present description, the hardness (breaking hardness) of the food granules is a value obtained by the following measurement method.

The breaking stress at the time when small pieces of dried meat are compressed at a constant compression rate is measured under the following conditions using a compression tester (TEXTUROMETER, model No: GTX-2, manufactured by ZENKEN CORPORATION). Plunger: cylindrical plunger having a diameter of 3 mm, Platform: flat plate, Compression rate: LOW, Output: 1 V, Lowest point of plunger: 2 mm (gap between flat plate and plunger), Measurement temperature: 25° C.

Specifically, one small piece of dried meat to be measured is placed on the flat plate, and stress is measured while a plunger is vertically pressed from the top of the small piece at a constant rate. A peak value (maximum value) of the stress is read as a value of the breaking stress. The measurement is repeated with respect to ten small pieces and the average value of the obtained values is acquired. The numerical value unit of the breaking hardness is converted into Newton (N) by multiplying the numerical value of the breaking stress (unit: kgw) measured using the compression tester described above by 9.8.

The hardness of the small piece of dried meat is set to a value measured immediately after the pet food product is opened within 30 days from the date of production or a value measured under conditions similar to the conditions described above.

### First Aspect: Dry Pet Food

A dry pet food according to one or more embodiments contains granules (hereinafter, also referred to as “food granules”) of an ingredient mixture containing a powder ingredient, at least one raw meat ingredient selected from the group consisting of animal meat and fish meat (hereinafter, also simply referred to as “raw meat ingredient”), and an oil and fat ingredient. Here, the term “granules of ingredient mixture” means food granules obtained by granulating the ingredient mixture in an extrusion forming machine such as an extruder. Details of a method of producing the dry pet food according to one or more embodiments will be described later.

### Powder Ingredient

The powder ingredient is not particularly limited, and well-known ingredients can be used. Examples of the powder ingredient include cereals (corn, wheat, rice, barley, oat, rye, and the like), beans (defatted soybeans, whole soybeans, and the like), starches (wheat starch, corn starch, rice starch, potato starch, tapioca starch, sweet potato starch, sago starch, and the like), vegetable protein sources (corn gluten meal, wheat gluten, soybean protein, and the like), meat (chicken, beef, pork, venison, meals (chicken meal, pork meal, beef meal, and mixed meal thereof), and the like), fishes and shellfishes (fish meat, meals (fish meal), and the like), vegetables, and powdery additives (vitamins, minerals, amino acids, flavoring ingredients, fibers, colorants, palantants, and the like).

Meals means powders obtained by compressing and finely crushing meat or fish and shellfish. Examples of palatants include animal-based extract, plant-based extract, yeast extract (beer yeast extract, baker's yeast extract, torula yeast extract), dry products of yeast (beer yeast, baker's yeast, torula yeast, and the like), and the like.

In one or more embodiments, the powder ingredient includes soybean protein. When the powder ingredient includes soybean protein, water contained in the raw meat ingredient is easily absorbed, and the ingredients are easily uniformly mixed. Therefore, the formability of the ingredient mixture is easily enhanced while the ingredient mixture contains a large amount of the raw meat ingredient.

Examples of the soybean protein include isolated soybean protein and concentrated soybean protein.

The soybean protein may be used alone or in combination of two or more thereof.

In a case where soybean protein is included in the powder ingredient, a content of the soybean protein is 5% to 30%, 7% to 25%, or 10% to 20%, with respect to the ingredients of the ingredient mixture. When the content of the soybean protein is within the above-mentioned ranges, the mass of protein in the dry pet food is easily adjusted to be within an appropriate range, and the ingredients are easily uniformly mixed.

In one or more embodiments, the powder ingredient may include corn as a cereal ingredient. The cereal ingredient may be either a corn dry milling product or a corn wet milling product. The term “corn dry milling product” means a pulverized product of corn obtained by processing with little use of water. The corn dry milling product has a lower content of starch than the wet milling product obtained by extracting a part of corn such as corn starch. This makes it easier to prevent adhesion of the granules in a granulating step, and makes it easier to obtain food granules having a shape, which makes it easier to enhance the yield rate.

Examples of the corn dry milling product include corn grits, corn meal, reduction flour, corn flour, corn jam, and hominy feed. Among these, reduction flour or corn flour may be selected as the corn dry milling product from the viewpoint of preventing the generation of lumps of the ingredient mixture and preventing the adhesion of the granules.

The corn dry milling product may be used alone or in combination of two or more thereof. In a case where the corn dry milling product is included in the powder ingredient, a content of the corn dry milling product is 10% to 40%, 15% to 35%, or 20% to 30%, with respect to the ingredients of the ingredient mixture.

When the content of the corn dry milling product is within the above-mentioned ranges, the mass of protein in the dry pet food is easily adjusted to be within an appropriate range, and the adhesion of the granules is easily prevented in the granulating step.

The powder ingredient may be used alone or in combination of two or more thereof. Among these, the powder ingredient may contain the soybean protein and the corn dry milling product.

A content of the powder ingredient is 40% to 60%, 50% to 60%, or 55% to 60%, with respect to the total amount of the ingredient mixture and with respect to the ingredients of the ingredient mixture.

When the content of the powder ingredient is within the above-mentioned ranges, the palatability is more easily enhanced.

### Raw Meat Ingredient

The raw meat ingredient is not particularly limited as long as it is animal meat and/or fish meat, and well-known ingredients can be used.

Examples of the animal meat include raw meats of cows, pigs, sheep, deer, rabbits, chickens, turkeys, quails, and the like.

Examples of the fish meat include fish meats of tuna, bonito, horse mackerel, mackerel, pacific saury, sardine, and the like.

The form of the raw meat ingredient is not particularly limited, and examples thereof include paste, slurry, and mince. Among these, slurry or paste may be selected as for the form of the raw meat ingredient from the viewpoint of facilitating uniform mixing of the ingredients.

In one or more embodiments, the raw meat ingredient may be fish meat. When fish meat is used as the raw meat ingredient, the formability is easily enhanced while the ingredient mixture contains a large amount of raw meat. Further, the palatability for pets (particularly, cats) is easily enhanced. In addition, in one or more embodiments, because a content of the raw meat ingredient is as high as more than 36% with respect to the total amount of the ingredient mixture, there is a case where the raw meat ingredient can be included in the dry pet food in an amount equal to or larger than a standard amount determined by the Pet Food Fair Trade Association. In this case, because a packaged piece that accommodates the dry pet food can be labeled with a notice that the dry pet food contains raw meat, the pet food is highly appealing to customers.

The raw meat ingredient may be used alone or in combination of two or more thereof. The content of the raw meat ingredient is more than 36%, more than 36% to 60%, more than 36% to 55%, or more than 36% to 50% with respect to the ingredients of the ingredient mixture. When the content of the raw meat ingredient is more than 36%, the palatability of the dry pet food is easily enhanced. In addition, there are cases where the raw meat ingredient whose amount is equal to or larger than the standard amount determined by the Pet Food Fair Trade Association is contained in the dry pet food. In this case, because a packaged piece that accommodates the dry pet food can be labeled with a notice that the dry pet food contains raw meat, the pet food is highly appealing to customers.

On the other hand, when the content of the raw meat ingredient is equal to or less than the upper limit value of the above-mentioned ranges, the ingredients are easily uniformly mixed, the blending balance with other ingredients is easily achieved, and the nutritional balance of the dry pet food is easily adjusted. Further, the formability of the ingredient mixture is easily enhanced.

In one or more embodiments, the raw meat ingredient may be a main ingredient of an ingredient mixture. Here, the term “main ingredient” means an ingredient that is blended in the largest amount with respect to the total amount of the ingredient mixture.

When the raw meat ingredient is a main ingredient of the ingredient mixture, the palatability is more easily enhanced.

### Oil and Fat Ingredient

The oil and fat ingredient is not particularly limited, and well-known ingredients can be used. Specific examples thereof include animal oils and fats such as chicken fat (chicken oil), pig fat (lard), beef fat (tallow), milk fat, and fish oil; and vegetable oils and fats such as olive oil, cacao oil, palm oil, palm kernel oil, coconut oil, coconut oil, camellia oil, soybean oil, and rapeseed oil.

Among these, oils and fats that are liquid at room temperature may be selected due to the high melting point and high handleability, and soybean oil may be selected.

The oil and fat ingredient may be used alone or in combination of two or more thereof. A content of the oil and fat ingredient is 2.5% or more, 3% or more, or 3.5% or more, with respect to the ingredients of the ingredient mixture.

An upper limit value of the content of the oil and fat ingredient is not particularly limited, and may be 8% or less, 6.5% or less, or 5% or less.

When the content of the oil and fat ingredient is within the above-mentioned ranges, while the ingredient mixture contains a large amount of raw meat, a variation in shape between the granules is suppressed, and a stable mouthfeel is easily achieved.

### Other Ingredients

The ingredient mixture may contain other ingredients excluding the powder ingredient, the raw meat ingredient, and the oil and fat ingredient.

Examples of other ingredients include water, liquid sugar, dietary fibers (cellulose and the like); herbs; vitamins; minerals; amino acids; sweeteners; colorants; preservatives; thickening stabilizers; processed starch; antioxidants; pH adjusting agents; seasonings; emulsifiers; swelling agents; and fragrances.

In one or more embodiments, a content of the dietary fibers in the ingredient mixture is 10% or less, 9% or less, or 8% or less, with respect to the total amount of the ingredient mixture. A lower limit value of the content of the dietary fibers is not particularly limited, and is 0% or more, 3% or more, or 5% or more.

When the content of the dietary fibers is within the above-mentioned ranges, the palatability is not easily lowered, and the ingredients are easily uniformly mixed.

In the dry pet food according to one or more embodiments, the hardness of the granules (food granules) of the ingredient mixture is 60 to 100 N, 70 to 90 N, or 75 to 85 N.

When the hardness of the food granules is within the above-mentioned ranges, the palatability is easily enhanced.

In the dry pet food according to one or more embodiments, the shape of the food granules may be any shape suitable for a pet to eat, and is not particularly limited. However, from the viewpoint of maintaining the shape of the food granules, the shape is a shape having an arc-shaped corner part, a spherical shape, or an elliptical shape. Here, the term “arc-shaped” refers to a shape that can be considered as a part of a circumference or a curve similar thereto, and means a shape in which the corner part of the food granule is rounded.

In the dry pet food according to one or more embodiments, the size of the food granules is not particularly limited as long as it is suitable for a pet to eat, and the size of the food granules may be such that a major axis is 6.0 to 9.0 mm, a minor axis is 5.5 to 8.5 mm, and a thickness is 2.5 to 4.5 mm. When the size of the food granules is within the above range, it is easy for a pet to eat.

A moisture content of the dry pet food obtained by the production method according to one or more embodiments is 3.0 to 12 mass %, 5.0 to 12 mass %, or 8.0 to 12 mass %, in a case of a pet food for dogs. In a case of a pet food for cats, the moisture content is 2.0 to 10 mass %, 3.0 to 9.0 mass %, or 4.0 to 8.0 mass %.

When the moisture content is within the above range, sufficient palatability can be obtained.

The dry pet food according to one or more embodiments may be stored in a packaged piece as it is and used as a pet food product, or the dry pet food may be mixed with other dry pet foods and may be stored in the packaged piece as a mixed pet food to be used as a pet food product. Specifically, the dry pet food according to one or more embodiments can be used as a topping granule and another dry pet food can be used as a main granule to obtain a mixed pet food.

The other dry pet food (main granule) in the mixed pet food is not particularly limited, and a well-known dry pet food that satisfies a comprehensive nutritional food standard can be adopted.

In a case of the mixed pet food, the topping granule may have an arc-shaped corner part, and the main granule has a shape having a modified cross section.

Examples of the shape of the main granule having a modified cross section includes a heart shape, a clover shape, a star shape, a cross shape, and a doughnut shape.

In a case where the topping granule and the main granule each have the above-described shape, it is easy to visually recognize that the mixed pet food contains different food granules. Further, when the topping granules and the main granules are mixed, the topping granules are less likely to lose the shape.

It should be noted that the shape of the main granules is not limited to the shape having a modified cross section, and may have a shape such as a circular shape, an elliptical shape, or a polygonal shape.

The hardness of the main granules is not particularly limited, and is 40 to 60 N. When the hardness of the topping granules is within the above-mentioned range, and the hardness of the main granules is within the above-mentioned range, the mouthfeel of the topping granules and the mouthfeel of the main granules are different, and therefore, the palatability is easily enhanced.

The size of the main granules is not particularly limited as long as it is suitable for a pet to eat. The size of the main granules may be such that a major axis is 5 to 15 mm, a minor axis is 5 to 15 mm, and a thickness is 2 to 5 mm, and the major axis may be 7 to 10 mm, the minor axis is 7 to 10 mm, and the thickness is 2 to 3 mm.

In the mixed pet food, the ratio of the main granule to the topping granule is 95:5 to 50:50, 70:30 to 90:10, or 90:10 to 80:20.

When the ratio of the main granule: topping granule is within the above-mentioned ranges, the palatability is easily enhanced.

### Method of Producing Dry Pet Food

As a method of producing the pet food according to one or more embodiments, a well-known method can be used, and there is no particular limitation as long as the composition of the above-described embodiments is satisfied. As the well-known method, there is provided a method of producing the pet food in the following order: a granulating step, a drying step, and a coating step.

### Granulating Step

In the granulating step, an ingredient mixture is granulated to obtain food granules. As a method of mixing ingredients to form an ingredient mixture, and a method of forming (granulating) the ingredient mixture into a granular shape, well-known methods can be used.

For example, a method of producing puffed granules using an extruder can be suitably used.

As the method of producing puffed granules using an extruder, for example, a method described in “Small Animal Clinical Nutrition 5th Edition” (edited by Michael S. Hand, Craig D. Thatcher, Rebecca L. Remillard, Philip Roudebusg, and Bruce J. Novotny, published by Mark Morris Associates; 2014; p. 209 to 215) can be used.

An example of the method of producing puffed granules using an extruder will be described. First, among the ingredients of the puffed granules, ingredients other than external additives are pulverized as necessary and then mixed. The ingredients may be mixed while being pulverized using a grinder or the like. Further, water (which is not included in the ingredient composition) is added thereto as necessary to obtain an ingredient mixture.

The obtained ingredient mixture is put into the extruder, heated, pressurized, and then extruded from an outlet. At the outlet, a plate in which a hole having a predetermined shape is formed, and a cutter that cuts the ingredient mixture extruded from the plate to have a predetermined length (thickness) are provided. The ingredient mixture is extruded from the hole of the plate and cut with the cutter to be formed into a predetermined shape, and at the same time, water vapor in the ingredient mixture is expanded by releasing from a pressurized state to an atmospheric pressure. Thereby, the ingredient mixture is puffed, and porous granules are obtained.

### Drying Step

The granules thus obtained are dried as necessary until the moisture content reaches a predetermined moisture content to obtain puffed granules (food granules). In a case of producing dry type food granules, the drying step is essential.

For example, the moisture content of the granules discharged from the extruder is 10 to 30 mass %. When moisture is contained in an amount of this degree, good formability is easily obtained.

The temperature of the granules discharged from the extruder depends on the heating temperature in the extruder. For example, the temperature is 90° C. to 150° C.

As a method of drying the granules discharged from the extruder, a well-known method can be appropriately used. Examples thereof include a hot air drying method of drying granules by blowing hot air to the granules, a reduced pressure drying method, and a method of frying granules in oil. For example, a hot air drying method using a conveyor type hot air dryer may be used.

The drying conditions (temperature and time) may be any conditions as long as the temperature of the granules is raised to 100° C. or higher to evaporate moisture in the granules without causing thermal denaturation of components in the granules so that the moisture content is adjusted to a value. For example, in a case where the granules are dried using a hot air dryer, the temperature of the hot air to be brought into contact with the granules is 100° C. to 140° C., or 100°° C. to 110° C. The drying time is not particularly limited, and the drying time is, for example, about 5 to 20 minutes.

After drying, the pet food may be coated with a coating agent containing oils and fats, seasonings, fragrances, or the like.

The coating method is not particularly limited, and can be performed by, for example, a vacuum coating method. The vacuum coating method is a method of reducing pressure in a state in which the coating agent is brought into contact with or attached to warmed food granules and then slowly releasing the food granules to the atmosphere. The coating agent may be in a liquid state or a powder state. By the coating, the palatability (biting property) for a pet can be enhanced.

### Second Aspect: Dry Pet Food

A dry pet food according to one or more embodiments contains a first granule (hereinafter, also referred to as “first food granule”) of a first ingredient mixture containing a powder ingredient, at least one raw meat ingredient selected from the group consisting of animal meat and fish meat, and an oil and fat ingredient, and a second granule (hereinafter, also referred to as “second food granule”) of a second ingredient mixture in which a content of the raw meat ingredient is lower than a content of the raw meat ingredient in the first ingredient mixture or no raw meat ingredient is contained.

### (First Food Granule)

The powder ingredient, the raw meat ingredient, and the oil and fat ingredient in the first ingredient mixture, which are the ingredients of the first food granule, are the same as the powder ingredient, the raw meat ingredient, and the oil and fat ingredient in the dry pet food according to the first aspect. However, the powder ingredient in the first ingredient mixture may or may not include soybean protein.

In the first ingredient mixture, the content of the raw meat ingredient in the first ingredient mixture is more than 36%, more than 36% to 60%, more than 36% to 55%, or more than 36% to 50%, with respect to the total amount of the first ingredient mixture.

When the content of the raw meat ingredient is more than 36%, the palatability of the dry pet food is easily enhanced. In addition, the raw meat ingredient whose amount is equal to or larger than the standard amount determined by the Pet Food Fair Trade Association is contained in the dry pet food. Therefore, because a packaged piece that accommodates the dry pet food can be labeled with a notice that the dry pet food contains raw meat, the pet food is highly appealing to customers.

On the other hand, when the content of the raw meat ingredient is equal to or less than the upper limit value of the above-mentioned ranges, the ingredients are easily uniformly mixed, the blending balance with other ingredients is easily achieved, and the nutritional balance of the dry pet food is easily adjusted. Further, the formability of the ingredient mixture is easily enhanced.

### (Second Food Granule)

The second food granules are not particularly limited as long as the granules are granules of the second ingredient mixture in which the content of the raw meat ingredient is lower than the content of the raw meat ingredient in the first ingredient mixture or no raw meat ingredient is contained, and a well-known dry pet food that satisfies the comprehensive nutritional food standard can be adopted.

In the dry pet food according to one or more embodiments, the first food granule may have an arc-shaped corner part and the second food granule has a modified cross section.

Examples of the shape of the second food granule having a modified cross section include a heart shape, a clover shape, a star shape, a cross shape, and a doughnut shape. It should be noted that the shape of the main granules is not limited to the shape having a modified cross section, and may have a shape such as a circular shape, an elliptical shape, or a polygonal shape. In a case where the first food granule and the second food granule each have the above-described shape, it is easy to visually recognize that the dry pet food contains different food granules. Further, when the first food granules and the second food granules are mixed, the first food granules are less likely to lose the shape.

Further, when the first food granule has an arc-shaped corner part, even in a case where the first ingredient mixture is likely to be inhomogeneous due to the inclusion of a large amount of the raw meat ingredient in the first ingredient mixture, the shape of the first food granule is easily maintained.

In the dry pet food according to one or more embodiments, a content ratio of the first food granules is less than 25%, 20% or less, or 15% or less, with respect the total amount of the first food granules and the second food granules.

When the content ratio of the first food granules is within the above-mentioned ranges, the palatability is easily enhanced.

In the mixed pet food, a ratio of the second food granules to the first food granules is 95:5 to 50:50, 70:30 to 90:10, or 90:10 to 80:20.

When the ratio of the second food granules to the first food granules is within the above-mentioned ranges, the palatability is easily enhanced.

In the dry pet food according to one or more embodiments, the first ingredient mixture may contain fish meat as the raw meat ingredient, and the second ingredient mixture contains fish meat excluding the fish meat contained in the first ingredient mixture. In this case, both the first food granules and the second food granules contain fish meat ingredients, which makes it easier to give a sense of unity to the entire dry pet food. In addition. Because the first food granule and the second food granule contain different fish meat ingredients, for example, in a case where a fish meat ingredient having a high scent effect is used for the first food granule, the first food granule becomes noticeable and the attractiveness is easily enhanced.

In the dry pet food according to one or more embodiments, the first food granule may have a darker color than the second food granule. In this case, the first food granule having a high scent level is more likely to be noticeable.

In one or more embodiments, the hardness, shape, and size of the first food granules are the same as the hardness, shape, and size of the food granules in the first aspect.

### Method of Producing Dry Pet Food

As a method of producing the pet food according to one or more embodiments, a well-known method can be used, and there is no particular limitation as long as the composition of the above-described embodiments is satisfied. As the well-known method, there is provided a method of producing the pet food in the following order: a granulating step, a drying step, and a coating step.

Specifically, the dry pet food according to one or more embodiments can be obtained by obtaining the first food granules and the second food granules in the same manner as in the method of producing the pet food according to the first aspect, and mixing the first food granules and the second food granules.

In one or more embodiments, the raw meat ingredient whose amount is equal to or larger than the standard amount determined by the Pet Food Fair Trade Association is contained in the dry pet food. Therefore, because a packaged piece that accommodates the dry pet food can be labeled with a notice that the dry pet food contains raw meat, the pet food is highly appealing to customers. Specifically, a photograph or a detailed illustration of fish can be attached to the packaged piece, which makes it possible to appeal to consumers that the pet food product contains fish meat and the dry pet food is a healthy and highly palatable dry pet food.

### EXAMPLES

Hereinafter, embodiments will be described in more detail with reference to Examples, but is not limited to these Examples.

### Examples 1 to 3: Production of Dry Pet Food (Topping Granule)

The ingredients shown in Table 1 were mixed to obtain an ingredient mixture. The obtained ingredient mixture was put into a trial extruder, subjected to a heat treatment while being kneaded, and extruded and granulated into a granular shape at the outlet of the trial extruder and puffed at the same time. The obtained food granules were dried using a dryer to obtain dry pet foods (topping granules) of Examples 1 to 3.

TABLE 1

| Ingredient | | Example 1 | Example 2 | Example 3 |
|---|---|---|---|---|
| Raw meat | Bonito | 40.0% | 40.0% | 40.0% |
| ingredient | | | | |
| Powder | Defatted soybean | | 12.0% | 12.0% |
| ingredient | Soybean protein | 20.0% | 15.0% | 15.0% |
| | Corn starch | 27.3% | 29.8% | |
| | Corn flour | | | 29.9% |
| | Palatability | 10.0% | | |
| | enhancer | | | |
| Oil and fat | Soybean oil | 2.50% | 2.50% | 2.50% |
| ingredient | | | | |
| Additive | Minerals | | 0.50% | 0.50% |
| | Antioxidant | 0.20% | 0.20% | 0.10% |

| | | | |
|---|---|---|---|
| Total | 100.0% | 100.0% | 100.0% |
| Palatability evaluation result | 57:43 | 55:45 | 58:42 |
| Ingredient mixing (presence or | B | B | A |
| absence of lumps) | | | |
| Success or failure of granulation | B | B | B |
| Presence or absence of adhesion | B | B | A |
| of granules | | | |

### (Evaluation of Existence of Lumps of Ingredient Mixture)

When the ingredients were mixed, the presence or absence of lumps of the ingredient mixture was visually evaluated according to the following criteria. The results are shown in Table 1 as “ingredient mixing (presence or absence of lumps)”.
A: Cleanly dispersed.
B: Process proceeds to next step without any problems.

### (Evaluation of Success or Failure of Granulation)

The success or failure of granulation was evaluated according to the following criteria. The results are shown in Table 1 as “Success or failure of granulation”.
A: Granulation is clearly formed without adhesion.
B: There is some adhesion, but granules can be produced without any problems.

### (Evaluation of Presence or Absence of Adhesion of Granules)

The presence or absence of the adhesion of the granules was evaluated according to the following criteria. The results are shown in Table 1 as “Presence or absence of adhesion of granules”.
A: Granulation is clearly formed without adhesion.
B: There is some adhesion, but granules can be produced without any problems.

### (Palatability Evaluation)

The ingredient mixture blended to satisfy the comprehensive nutritional food standard was put into an extruder, subjected to a heat treatment while being kneaded, and then extruded and granulated into a granular shape at the outlet of the extruder and puffed at the same time. The obtained food granules were dried using a dryer to obtain a dry pet food having the obtained food granules as main granules.

The obtained main granules were mixed with the dry pet food (topping granule) of each test example in ratios in Table 1 to obtain mixed pet foods.

The palatability of each of mixed pet food P and the main granule pet food Q was evaluated by comparing the food intake. Twenty cats were monitored and tested for two days.

On the first day, the pet foods P and Q were fed simultaneously, one from the left side and the other from the right side, at a predetermined feed amount to one cat, and the amount of the pet food eaten by the cat was measured at the time when or 30 minutes after the cat completely consumed either one of the pet foods P and Q.

The ratio (P:Q, P+Q=100%) of the intake of pet food Q and the intake of pet food P with respect to the total mass of the pet food eaten by the cat on the first day, was calculated as a percentage. The percentages obtained, based on the number of cats monitored, were averaged as the results of the first day.

On the second day, the pet foods P and Q were fed simultaneously, one from the right side and the other from the left side, contrary to the first day. One cat was fed the same amount as on the first day, and the amount of pet food eaten by the cat was measured at the time when or 1 hour after the cat completely consumes either one of the pet foods. The results of the second day were obtained by the similar calculation method as that of the first day.

Finally, the results of the first day and the second day were averaged to calculate the ratio “P:Q” of the food intake of pet food P:pet food Q, which is the final result. A higher value of P or Q indicates that the cat serving as the monitor tends to eat. In a case where the value of P is higher than 50%, this case means that the palatability is enhanced compared with the pet food Q. The results are shown in Table 1 as “Palatability evaluation result”.

From the results shown in Table 1, it was confirmed that in Examples 1 to 3, the generation of lumps of the ingredient mixture was suppressed, granulation was also possible, and the adhesion of the granules after extrusion from the extruder was also suppressed. Further, it was confirmed that the mixed pet foods in which the dry pet foods obtained in Examples 1 to 3 were mixed as topping granules had enhanced palatability compared with the pet food containing only the main granules. Particularly, in Example 3, it was confirmed that the effect of suppressing the generation of lumps of the ingredient mixture and suppressing the adhesion of the granules after extrusion from the extruder was high.

### Examples 4 to 6: Production of Dry Pet Food (Topping Granule)

The ingredients shown in Table 2 were mixed to obtain an ingredient mixture. The obtained ingredient mixture was put into an extruder, subjected to a heat treatment while being kneaded, and then extruded and granulated into a granular shape at the outlet of the extruder and puffed at the same time. The obtained food granules were dried using a dryer to obtain dry pet foods (topping granules) of Examples 4 to 6.

TABLE 2

| Ingredient | | Example 4 | Example 5 | Example 6 |
|---|---|---|---|---|
| Raw meat | Bonito | 40.0% | 40.0% | 40.0% |
| ingredient | | | | |
| Powder | Defatted soybean | 15.0% | 11.0% | 10.5% |
| ingredient | Soybean protein 1 | 14.0% | 14.0% | |
| | Soybean protein 2 | | | 13.0% |
| | Corn flour | 26.60% | 26.90% | 27.90% |
| | Palatability | | 3.50% | 3.50% |
| | enhancer | | | |
| Oil and fat | Soybean oil | 3.50% | 4.00% | 4.50% |
| ingredient | | | | |
| Additive | Minerals | 0.80% | 0.50% | 0.50% |
| | Antioxidant | 0.10% | 0.10% | 0.10% |

| | | | |
|---|---|---|---|
| Total | 100.0% | 100.0% | 100.0% |
| Palatability evaluation result | 52:48 | 58:42 | 56:44 |
| Ingredient mixing (presence or | A | A | A |
| absence of lumps) | | | |
| Success or failure of granulation | A | A | A |
| Presence or absence of adhesion | A | A | A |
| of granules | | | |

For Examples 4 to 6, in the same manner as in Examples 1 to 3, “Evaluation of presence or absence of lumps of ingredient mixture”, “Evaluation of success or failure of granulation”, “Evaluation of presence or absence of adhesion of granules”, and “Palatability evaluation” were performed. The results are shown in Table 2.

From the results shown in Table 2, it was confirmed that in Examples 4 to 6, the generation of lumps of the ingredient mixture was suppressed, granulation was also possible, and the adhesion of the granules after extrusion from the extruder was also suppressed. Further, it was confirmed that the mixed pet foods in which the dry pet foods obtained in Examples 4 to 6 were mixed as topping granules had enhanced palatability compared with the pet food containing only the main granules.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### INDUSTRIAL APPLICABILITY

One or more embodiments provide a dry pet food which contains a large amount of raw meat ingredient, has good palatability, and is highly appealing to recipients, and a method of producing the same.

What is claimed is:

1. A dry pet food comprising:
granules of an ingredient mixture that includes:
a powder ingredient including soybean protein;
a raw meat ingredient consisting of one or both of animal meat and fish meat; and
an oil and fat ingredient, wherein
a content of the raw meat ingredient is more than 36% with respect to a total amount of the ingredient mixture.

2. The dry pet food according to claim 1, wherein the raw meat ingredient is a main ingredient of the ingredient mixture.

3. The dry pet food according to claim 1, wherein a content of the soybean protein is 5% to 30% with respect to the total amount of the ingredient mixture.

4. The dry pet food according to claim 1, wherein a content of dietary fibers in the ingredient mixture is equal to or less than 10% with respect to the total amount of the ingredient mixture.

5. The dry pet food according to claim 1, wherein the powder ingredient further includes corn.

6. The dry pet food according to claim 1, wherein a content of the oil and fat ingredient is equal to or greater than 3.5% with respect to the total amount of the ingredient mixture.

7. A dry pet food comprising:
a first granule of a first ingredient mixture that includes:
a powder ingredient;
a raw meat ingredient consisting of one or both of animal meat and fish meat; and
an oil and fat ingredient; and
a second granule of a second ingredient mixture that either has a lower content of a raw meat ingredient than the first ingredient mixture or contains no raw meat ingredient, wherein
a content of the raw meat ingredient of the first ingredient mixture is more than 36% with respect to a total amount of the first ingredient mixture.

8. The dry pet food according to claim 7, wherein a content ratio of the first granule is less than 25% with respect to a total amount of the first granule and the second granule.

9. The dry pet food according to claim 7, wherein
the first granule has an arc-shaped corner part, and
the second granule has a modified cross section.

10. The dry pet food according to claim 7, wherein
the first ingredient mixture includes the raw meat ingredient consisting of the fish meat, and
the second ingredient mixture includes fish meat different from the fish meat in the first ingredient mixture.

11. The dry pet food according to claim 7, wherein the first granule has a darker color than the second granule.
